(19) United States
(12) Patent Application Publication
(10) Pub. No.: US 2026/0222460 A1
(43) Pub. Date: Jul. 30, 2026

(54) WIRELESS AUXILIARY STREAM DEVICE, AND SCREEN PROJECTION METHOD AND SYSTEM BASED ON WIRELESS AUXILIARY STREAM DEVICE

(71) Applicant: YEALINK (XIAMEN) NETWORK TECHNOLOGY CO., LTD., Xiamen (CN)

(72) Inventor: Wanjian Feng, Xiamen (CN)

(21) Appl. No.: 19/408,285

(22) Filed: Dec. 3, 2025

(30) Foreign Application Priority Data
Jan. 24, 2025 (CN) 202510116964.0

(51) Int. Cl. H04L 65/403; H04N 7/04; H04N 9/31

(52) U.S. Cl. CPC H04L 65/403; H04N 7/04; H04N 9/3141

(57) ABSTRACT

A wireless auxiliary stream device includes: a first transmission module configured to establish a communication connection between the wireless auxiliary stream device and a terminal device, where the wireless auxiliary stream device receives audio and video data from the terminal device through the first transmission module; a second transmission module configured to wirelessly send the audio and video data received by the wireless auxiliary stream device to a video conferencing host, such that the audio and video data is displayed or played on an audio and video device connected to the video conferencing host; and a power supply module configured to supply power to the wireless auxiliary stream device, such that the wireless auxiliary stream device is in a standby mode, where the power supply module has a power supply mode and a charging mode. The wireless auxiliary stream device significantly improves efficiency of auxiliary stream transmission (content sharing).

### CROSS-REFERENCE TO RELATED APPLICATIONS

The present application claims the benefit of Chinese Patent Application No. 202510116964.0 filed on January 24, 2025, the contents of which are hereby incorporated by reference.

### TECHNICAL FIELD

The present disclosure relates to the technical field of data processing, and in particular, to a fast-started wireless auxiliary stream device, and a screen projection method and system based on the wireless auxiliary stream device.

### BACKGROUND

With the rapid development of science and technology, people's demand for content sharing is increasingly growing. In a conference scenario, content displayed on a terminal device such as a computer or a mobile phone needs to be synchronized to a video conferencing device for displaying. Currently, a common approach is to transmit audio and video signals to an external display screen or video conferencing device in a wired manner through a display output interface of a computer, for example, a video graphics array (VGA) interface, a digital visual interface (DVI), a high definition multimedia interface (HDMI), or a DisplayPort (DP). However, due to inconsistent video output interfaces of computers, different computers may be configured with different types of video output interfaces. As a result, a conference projection device or an auxiliary stream sending device needs to be equipped with a plurality of different interfaces and connection lines to be compatible with different computers. This results in disorganized connection lines on a desktop, increases deployment difficulty significantly, and causes an unnecessary cost waste due to purchase of a large number of connection cables of different specifications. Therefore, a wireless screen projection device or a wireless auxiliary stream device is used more frequently. According to the existing technological means, during screen projection, a universal serial bus (USB) wireless auxiliary stream device is first connected to a laptop and is powered by a USB interface of the laptop. This means that the USB wireless auxiliary stream device needs to establish a connection to the laptop to obtain required startup power before it can be powered on and runs, and then establishes a wireless connection to the video conferencing device, thereby achieving smooth transmission of audio and video data and ultimately realizing a screen projection outcome. However, there are significant shortcomings in the prior art. It takes a long time for the USB wireless auxiliary stream device to connect to the laptop, obtain a sufficient electricity quantity for startup, and complete initialization. In a practical application scenario, a user usually needs to wait for more than ten seconds or even longer after inserting the USB wireless auxiliary stream device into the laptop. The extremely long waiting time greatly reduces efficiency of auxiliary stream transmission (content sharing), and also plunges user experience to a bottom, causing many obstacles to a daily office process.

### SUMMARY

The present disclosure provides a fast-started wireless auxiliary stream device, which can achieve wireless communication between a terminal device and a video conferencing host, thereby efficiently transmitting audio and video data. The wireless auxiliary stream device is internally equipped with a power supply module, and the power supply module can enable the wireless auxiliary stream device to enter a standby mode, so as to solve a problem of long startup time of a wireless auxiliary stream device in the prior art, thereby significantly improving efficiency of auxiliary stream transmission (content sharing) and enhancing user experience.

In order to achieve the above objective, the present disclosure provides a wireless auxiliary stream device, where the wireless auxiliary stream device is communicatively connected to a terminal device; the wireless auxiliary stream device is wirelessly connected to a video conferencing host; and the terminal device communicates wirelessly with the video conferencing host through the wireless auxiliary stream device to transmit audio and video data. The wireless auxiliary stream device includes: a first transmission module configured to establish a communication connection between the wireless auxiliary stream device and the terminal device, where the wireless auxiliary stream device receives the audio and video data from the terminal device through the first transmission module; a second transmission module configured to wirelessly send the audio and video data received by the wireless auxiliary stream device to the video conferencing host, such that the audio and video data is displayed or played on an audio and video device connected to the video conferencing host; a power supply module configured to supply power to the wireless auxiliary stream device, such that the wireless auxiliary stream device is maintained in a standby mode, where the power supply module has a power supply mode and a charging mode; and a processor connected separately to the first transmission module, the second transmission module, and the power supply module and configured to control the connected first transmission module, second transmission module, and power supply module.

As a preferred solution, the power supply module is connected to the first transmission module and the second transmission module, and is configured to directly supply power to the first transmission module and the second transmission module to provide an electricity quantity required for transmitting the audio and video data.

As a preferred solution, the power supply module is a rechargeable battery.

As a preferred solution, the first transmission module of the wireless auxiliary stream device further includes a charging interface, and when the wireless auxiliary stream device is communicatively connected to the terminal device through the first transmission module, the terminal device charges the power supply module through the charging interface of the first transmission module.

As a preferred solution, the terminal device supplies power to the second transmission module through the first transmission module to provide an electricity quantity required for wirelessly sending the audio and video data received by the wireless auxiliary stream device to the video conferencing host.

As a preferred solution, the first transmission module is configured to send a first signal to the power supply module when being communicatively connected to the terminal device, and the power supply module is configured to switch to the charging mode after receiving the first signal.

As a preferred solution, the wireless auxiliary stream device further includes a power detection module, where the power detection module is configured to detect a current electricity quantity of the power supply module; and after the first transmission module is communicatively connected to the terminal device, the power detection module is further configured to control the power supply module to switch to the charging mode when detecting that the current electricity quantity of the power supply module is lower than a preset threshold.

As a preferred solution, the wireless auxiliary stream device further includes a charging module, where the wireless auxiliary stream device charges the power supply module through the charging module.

As a preferred solution, the first transmission module is a universal physical interface, and the second transmission module is a wireless transmission module.

The present disclosure further provides a screen projection method based on a wireless auxiliary stream device, applied to the wireless auxiliary stream device, where the wireless auxiliary stream device is communicatively connected to a terminal device; the wireless auxiliary stream device is wirelessly connected to a video conferencing host; the terminal device communicates wirelessly with the video conferencing host through the wireless auxiliary stream device to transmit audio and video data; and the screen projection method includes: obtaining electric power from a power supply module of the wireless auxiliary stream device to supply power to the wireless auxiliary stream device, such that the wireless auxiliary stream device is maintained in a standby mode, where the power supply module has a power supply mode and a charging mode; when a first transmission module of the wireless auxiliary stream device is communicatively connected to the terminal device, switching the wireless auxiliary stream device from the standby mode to a working mode; receiving the audio and video data from the terminal device through the first transmission module, and transmitting the received audio and video data to a second transmission module of the wireless auxiliary stream device; and wirelessly sending the received audio and video data to the video conferencing host through the second transmission module.

As a preferred solution, when the first transmission module is communicatively connected to the terminal device, a first signal is sent to the power supply module through the first transmission module, such that the power supply module switches to the charging mode after receiving the first signal.

As a preferred solution, after the first transmission module is communicatively connected to the terminal device, a current electricity quantity of the power supply module is detected, and the power supply module is controlled to switch to the charging mode when the current electricity quantity is lower than a preset threshold.

The present disclosure further provides a screen projection system containing a wireless auxiliary stream device, including the wireless auxiliary stream device, a terminal device, and a video conferencing host, where the wireless auxiliary stream device is communicatively connected to the terminal device; the wireless auxiliary stream device is wirelessly connected to the video conferencing host; and the terminal device communicates wirelessly with the video conferencing host through the wireless auxiliary stream device to transmit audio and video data.

Compared with the prior art, the embodiments of the present disclosure have following beneficial effects:

The present disclosure provides a wireless auxiliary stream device. The wireless auxiliary stream device includes: a first transmission module configured to establish a communication connection between the wireless auxiliary stream device and a terminal device, where the wireless auxiliary stream device receives audio and video data from the terminal device through the first transmission module; a second transmission module configured to wirelessly send the audio and video data received by the wireless auxiliary stream device to a video conferencing host, such that the audio and video data is displayed or played on an audio and video device connected to the video conferencing host; and a power supply module configured to supply power to the wireless auxiliary stream device, such that the wireless auxiliary stream device is maintained in a standby mode, where the power supply module has a power supply mode and a charging mode. Compared with the prior art, the wireless auxiliary stream device is internally equipped with the power supply module. The power supply module can enable the wireless auxiliary stream device to maintain the standby mode, such that the wireless auxiliary stream device can quickly switch from the standby mode to a working mode, so as to solve a problem of long startup time of a wireless auxiliary stream device in the prior art, thereby significantly improving efficiency of auxiliary stream transmission (content sharing) and enhancing user experience.

### BRIEF DESCRIPTION OF THE DRAWINGS

FIG. 1 is a schematic diagram of an application scenario of a wireless auxiliary stream device according to the present disclosure;

FIG. 2 is a schematic structural diagram of a wireless auxiliary stream device according to an embodiment of the present disclosure;

FIG. 3 is a schematic structural diagram of a wireless auxiliary stream device according to another embodiment of the present disclosure;

FIG. 4 is a schematic structural diagram of a wireless auxiliary stream device according to another embodiment of the present disclosure; and

FIG. 5 is a flowchart of a screen projection method based on a wireless auxiliary stream device according to the present disclosure.

### DETAILED DESCRIPTION

In the embodiments of the present disclosure, "exemplary", "for example", or the like is used to represent giving an example, an illustration, or a description. Any embodiment or design solution described herein as "exemplary" or "for example" in the embodiments of the present disclosure should not be construed as being more preferred or advantageous over other embodiments or design solutions. Exactly, use of "exemplary", "for example", or the like is intended to present a related concept in a specific manner.

The terms such as "first" and "second" used in the embodiments of the present disclosure are only for the purpose of description and should not be construed as indicating or implying relative importance, or implicitly indicating a quantity of indicated technical features. Thus, features defined with "first" and "second" may explicitly or implicitly include at least one of the features.

In the description of the present disclosure, unless otherwise specified, "a plurality of" means two or more. In the present disclosure, the term "at least one" refers to one or more, and the term "a plurality of" refers to two or more.

It should be understood that the term "one embodiment", "an embodiment", or "a possible implementation" mentioned in the specification means that a specific feature, structure, or characteristic related to the embodiment or the implementation is included in at least one embodiment of the present disclosure. Therefore, the phrase "in one embodiment", "in an embodiment", or "in a possible implementation" that appears everywhere throughout the specification does not necessarily refer to a same embodiment. Furthermore, particular features, structures, or characteristics may be combined in at least one embodiment in any suitable manner.

The technical solutions in the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure provides a wireless auxiliary stream device, which can quickly achieve wireless communication between a terminal device and a video conferencing host, thereby efficiently transmitting audio and video data. The wireless auxiliary stream device is internally equipped with a power supply module, and the power supply module can enable the wireless auxiliary stream device to enter a standby mode, so as to solve a problem of long startup time of a wireless auxiliary stream device in the prior art, thereby significantly improving efficiency of auxiliary stream transmission (content sharing) and enhancing user experience.

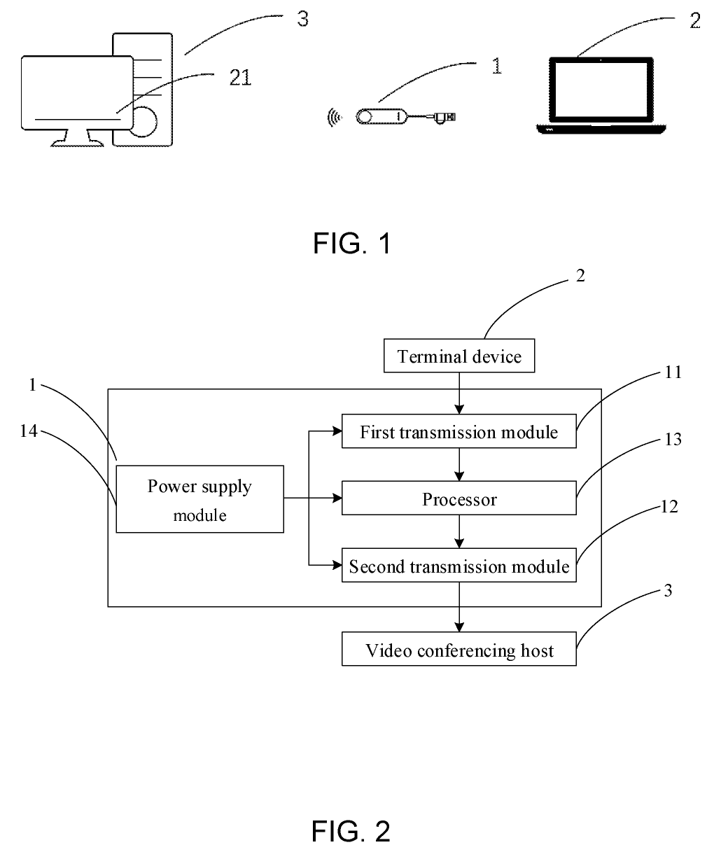

FIG. 1 shows an application scenario of a wireless auxiliary stream device 1 according to an embodiment of the present disclosure. In a practical application scenario of auxiliary stream sharing, the wireless auxiliary stream device 1, a terminal device 2, and a video conferencing host 3 may be located in a same physical location such as a same conference room, and jointly constitute a wireless auxiliary stream sharing system. The wireless auxiliary stream device 1 involved in the present disclosure has a capability of building a wireless communication link between the terminal device 2 and the video conferencing host 3, thereby efficiently transmitting audio and video data. The wireless auxiliary stream device 1 is equipped with a first transmission module that may be a universal physical interface. Through the physical interface, the wireless auxiliary stream device 1 can not only establish a physical connection to the terminal device 2, but also receive audio and video data and control information that are transmitted by the terminal device 2. Then, the above data is transmitted to the video conferencing host 3 through a second transmission module such as a wireless transmission module of the wireless auxiliary stream device 1, and finally displayed or played on an audio and video device connected to the video conferencing host 3. The video conferencing host 3 may be separately connected to a display device and a speaker device, or may be integrated with the display device and the speaker device. It should be pointed out that the wireless auxiliary stream device 1 is a standalone device with an independent hardware structure and is not integrated into the terminal device 2.

When screen projection or auxiliary stream sharing needs to be performed, the terminal device 2 is connected to the wireless auxiliary stream device 1 through the universal physical interface. The terminal device 2 generates to-be-projected data and transmits the to-be-projected data to the wireless auxiliary stream device 1 through the physical interface. The physical interface not only includes a common USB interface, but also includes a graphic display output interface, such as a VGA interface with an analog signal transmission capability, a DP that supports high-resolution and multi-channel audio transmission, a DVI that uses digital signal transmission to ensure image stability, and an HDMI that can simultaneously transmit high-quality audio and video signals. The wireless auxiliary stream device 1 is equipped with the wireless transmission module that is used to establish a wireless connection to the video conferencing host 3. The wireless auxiliary stream device 1 sends the to-be-projected data received from the terminal device 2 to the video conferencing host 3 through its own wireless transmission module and network resource to perform screen projection and displaying. In this process, the terminal device 2 does not need to directly establish a connection to the video conferencing host 3, effectively saving a network resource of the terminal device 2 and allowing the terminal device 2 to use its own network while performing the screen projection freely. After a user adds an annotation to the to-be-projected data on a display screen of the video conferencing host 3, if the annotation also needs to be synchronized to the terminal device 2, annotated to-be-projected data is reversely transmitted to the wireless auxiliary stream device 1 through the wireless transmission module. Then, the wireless auxiliary stream device 1 transmits the annotated to-be-projected data to the terminal device 2 through the physical interface for displaying. In this way, the wireless auxiliary stream device 1 bears a network resource consumption of data transmission, thereby saving a network resource of the video conferencing host 3, and achieving an optimal resource configuration of a screen projection system. The wireless transmission module herein may be a common wireless transceiver module such as a wireless fidelity (WIFI) module or a Bluetooth module. In addition, this embodiment takes one wireless auxiliary stream device as an example. Actually, there may be a plurality of wireless auxiliary stream devices 1 wirelessly connected to the video conferencing host 3. After the video conferencing host 3 simultaneously receives to-be-projected data from a plurality of terminal devices 2, the to-be-projected data is displayed in a split-screen manner on the corresponding display device of the video conferencing host 3.

FIG. 2 is a schematic structural diagram of the wireless auxiliary stream device 1 according to an embodiment of the present disclosure. The wireless auxiliary stream device 1 in this embodiment includes a first transmission module 11, a second transmission module 12, a processor 13, and a power supply module 14. The processor 13 is separately connected to each module, and ultimately manages and controls a working mode of the wireless auxiliary stream device 1 by controlling the connected first transmission module 11, second transmission module 12, and power supply module 13. For example, the processor 13 has a device control function, and controls a running status of the wireless auxiliary stream device, for example, manages and controls various parameter settings for wireless transmission or how to establish a connection to the video conferencing host 3. The first transmission module 11 is configured to establish a communication connection between the wireless auxiliary stream device 1 and the terminal device 2. The wireless auxiliary stream device 1 receives the audio and video data from the terminal device 2 through the first transmission module 11. The audio and video data is the to-be-projected data of the terminal device 2, such as the audio and video data generated by various application programs running on the terminal device 2, for example, content data such as a document, an image, a video, and a presentation, and may also include metadata such as format information and a display setting that are related to the audio and video data. In addition, some control data of the terminal device 2 can also be transmitted through the first transmission module 11 to perform screen projection control on the wireless auxiliary stream device 1, for example, to start or end the screen projection, or select a screen projection direction, that is, whether to send the audio and video data from the terminal device 2 to the video conferencing host 3 or receive the audio and video data from the video conferencing host 3. The second transmission module 12 is configured to send the audio and video data received from the first transmission module 11 to the video conferencing host 3 through a wireless network, such that the audio and video data is displayed or played on the audio and video device connected to the video conferencing host 3. The power supply module 14 is configured to supply power to each module of the wireless auxiliary stream device 1, such that the wireless auxiliary stream device 1 is maintained in a standby mode. The power supply module 14 has a power supply mode and a charging mode, The first transmission module 11 is a physical interface with a data transmission function, which not only includes the common USB interface, but also includes the graphic display output interface, such as the VGA interface with the analog signal transmission capability, the DP that supports the high-resolution and multi-channel audio transmission, the DVI that uses the digital signal transmission to ensure the image stability, and the HDMI that can simultaneously transmit the high-quality audio and video signals. The second transmission module 12 is a wireless transmission module, for example, the common wireless transceiver module like the WIFI module or the Bluetooth module. For example, in this embodiment, the wireless auxiliary stream device 1 is communicatively connected to the terminal device 2 through the USB interface, and wirelessly connected to the video conferencing host 3 through the WIFI module. That is, the terminal device 2 communicates wirelessly with the video conferencing host 3 through the wireless auxiliary stream device 1 to transmit the audio and video data, thereby ultimately transmitting, displaying, and playing the to-be-projected data.

Specifically, the power supply module 14 can independently supply power to the wireless auxiliary stream device to enable the wireless auxiliary stream device to be in the standby mode. When the wireless auxiliary stream device 1 is disconnected from the terminal device 2, the power supply module 14 immediately continues to supply power to the wireless auxiliary stream device 1, such that the wireless auxiliary stream device 1 is maintained in the standby mode. At this time, the power supply module 14 is in the power supply mode. The standby mode of the wireless auxiliary stream device is a mode in which the wireless auxiliary stream device does not transmit the to-be-projected data actually but can work at any time. In the standby mode, most functional modules of the wireless auxiliary stream device are in a low-power running mode to reduce an energy consumption. For example, the first transmission module 11, the second transmission module 12, and the processor 13 only maintain basic operational monitoring, thereby reducing unnecessary calculations and signal emission. In addition, the wireless auxiliary stream device 1 will continuously monitor a connection status with the terminal device 2 or maintain a connection status with the video conferencing host 3, and can quickly respond, wake up a relevant functional module, and enter a normal working mode once detecting a connection request or a screen projection instruction from the terminal device 2. Ideally, the power supply module 14 is a rechargeable battery, and maintains a relatively stable electricity quantity through the charging mode, so as to provide necessary power support to the wireless auxiliary stream device 1 at any time during the standby mode, ensure that the wireless auxiliary stream device can quickly switch from the standby mode to the working mode, and shorten response time.

As a preferred solution, the power supply module 14 is connected to the first transmission module 11 and the second transmission module 12, and directly supplies power to the first transmission module 11 and the second transmission module 12 to provide an electricity quantity required for transmitting the to-be-projected data such as the audio and video data. That is, when the wireless auxiliary stream device 1 is connected to the terminal device 2, the wireless auxiliary stream device 1 is in a stage of transmitting the to-be-projected data. After establishing a signal connection to the terminal device 2, the first transmission module 11 begins to receive the to-be-projected data transmitted by the terminal device 2. Subsequently, the to-be-projected data is quickly transmitted to the second transmission module 12. After receiving the to-be-projected data, the second transmission module 12 quickly transmits the to-be-projected data to the display device (such as the video conferencing host 3). In addition, in the stage of transmitting the to-be-projected data, the processor 13 also obtains power from the power supply module 14. In the wireless auxiliary stream device 1, the processor 13 parses and verifies the received to-be-projected data from the terminal device 2 to ensure data integrity and accuracy, and then performs data repackaging, data encryption, and the like based on a requirement of the second transmission module 12, so as to efficiently send the to-be-projected data to the video conferencing host 3. In this process, due to stable and reliable power supply, the wireless auxiliary stream device 1 can enter the working mode before being powered on and initialized, and the second transmission module 12 can start wireless data transmission before pairing with and connecting to the video conferencing host 3, thereby greatly reducing waiting time for screen sharing and significantly improving sharing efficiency.

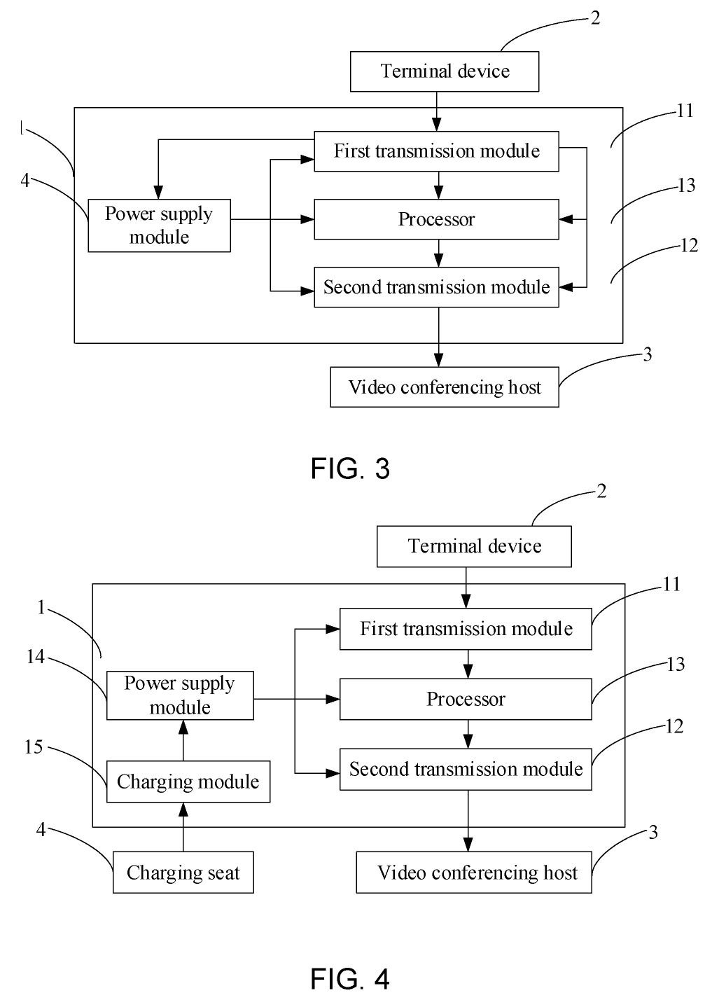

FIG. 3 is a schematic structural diagram of the wireless auxiliary stream device 1 according to another embodiment of the present disclosure. In this embodiment, the first transmission module 11 of the wireless auxiliary stream device 1 further includes a charging interface (not shown in the figure). When the wireless auxiliary stream device 1 is communicatively connected to the terminal device 2 through the first transmission module 11, the terminal device charges the power supply module 14 through the charging interface of the first transmission module 11. The charging interface and a data transmission interface with the data transmission function may be integrated into a same physical interface, or may be two separate independent data ports. For example, in this embodiment, the first transmission module 11 is the USB interface, that is, the charging interface and the data transmission interface are integrated into the same physical interface, which may be, for example, the USB interface and can be used for charging and data transmission simultaneously. Therefore, in the stage of transmitting the to-be-projected data, the power supply module can be charged synchronously without a need to dispose an additional charging module or separately charge the wireless auxiliary stream device, providing the user with more convenient charging and use experience.

As a preferred solution, the terminal device is separately connected to the processor 13 and the second transmission module 12 through the first transmission module 11, that is, the terminal device 2 supplies power to the first transmission module 11, the processor 13, and the second transmission module 12. The terminal device 2 supplies power to the second transmission module 12 through the first transmission module 11 to provide an electricity quantity required for wirelessly sending the audio and video data received by the wireless auxiliary stream device to the video conferencing host 3. The terminal device 2 supplies power to the processor 13 through the first transmission module 11 to provide an electricity quantity required for normal working of the processor 13, such as an electricity quantity required for the processor to parse and verify the to-be-projected data to ensure the data integrity and accuracy, perform the data repackaging and encryption, and the like. When the user establishes an electrical connection between the first transmission module 11 and the terminal device 2, the first transmission module 11 is simultaneously used for charging and power supply. That is, the first transmission module 11 supplies power to the processor 13 and the second transmission module 12, and charges the power supply module 14. This ensures that the wireless auxiliary stream device 1 has continuous and stable power support during running, prevents electric energy of the power supply module 14 from being exhausted, and maintains an electricity quantity required for maintaining the standby mode of the wireless auxiliary stream device 1, thereby greatly shortening the waiting time for the screen sharing and significantly improving the sharing efficiency.

As a preferred solution, the first transmission module 11 is configured to send a first signal to the power supply module 14 when being communicatively connected to the terminal device 2, and the power supply module 14 switches to the charging mode after receiving the first signal. This embodiment takes the USB interface as an example. When the wireless auxiliary stream device 1 is inserted into the terminal device 2 through the USB interface, the terminal device 2 can send a control signal, namely, the first signal, to the wireless auxiliary stream device 1 through the first transmission module 11, and control the power supply module 14 to switch to the charging mode. Ideally, the power supply module 14 switches to the charging mode only after the terminal device 2 provides an electricity quantity required for normal working of the wireless auxiliary stream device 1 through the first transmission module 11, so as to synchronously maintain an electricity quantity required for the normal working and the subsequent standby mode of the wireless auxiliary stream device 1. This ensures that the wireless auxiliary stream device 1 can quickly switch from the standby mode to the working mode, and shortens the response time.

As a preferred solution, the wireless auxiliary stream device 1 further includes a power detection module (not shown in the figure). The power detection module is configured to detect a current electricity quantity of the power supply module. After the first transmission module 11 is communicatively connected to the terminal device 2, the power detection module switches the power supply module 14 to the charging mode when detecting that the current electricity quantity of the power supply module is lower than a preset threshold. Specifically, the preset threshold may be an electricity quantity required by the wireless auxiliary stream device 1 to maintain the standby mode for 3 to 15 hours, to ensure a sufficient battery life for the wireless auxiliary stream device 1 to maintain the standby mode. When being connected to the terminal device, the wireless auxiliary stream device 1 can quickly switch to the working mode without a need to wait for power-on and initialization of the wireless auxiliary stream device 1 and a pairing and connection process between the second transmission module 12 and the video conferencing host 3, greatly reducing the waiting time for the screen sharing and significantly improving the sharing efficiency.

FIG. 4 is a schematic structural diagram of the wireless auxiliary stream device 1 according to another embodiment of the present disclosure. In this embodiment, the wireless auxiliary stream device 1 further includes a charging module 15, and the wireless auxiliary stream device 1 charges the power supply module 14 through the charging module 15. The charging module 15 supports both wired charging and wireless charging. This embodiment takes the wireless charging for the wireless auxiliary stream device 1 as an example. For example, a charging seat 4 may include a primary coil and a power conversion circuit. The power conversion circuit converts an input alternating current into an alternating current signal suitable for the primary coil to generate an alternating magnetic field. The charging module 15 may include a secondary coil and a rectification and voltage stabilization circuit for converting an induced current into a direct current that can be used to charge a battery. The power supply module 14 of the wireless auxiliary stream device 1 can be charged through the charging module 15 only by placing the wireless auxiliary stream device 1 on the charging seat 4, such that the power supply module 14 has at least an electricity quantity required to enable the wireless auxiliary stream device 1 to be in the standby mode, so as to provide the necessary power support to the wireless auxiliary stream device 1 at any time during the standby mode. This ensures that the wireless auxiliary stream device can quickly switch from the standby mode to the working mode, achieves fast startup of the wireless auxiliary stream device, and shortens the response time.

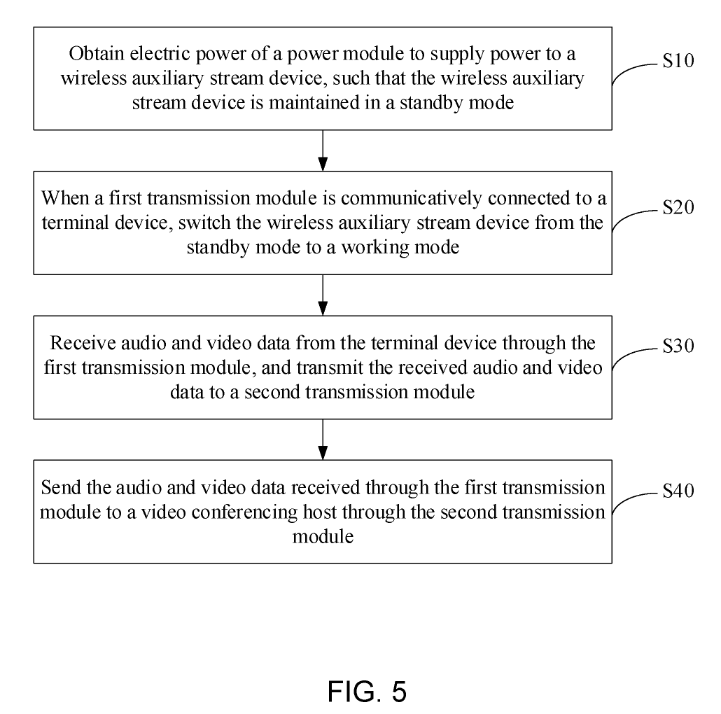

FIG. 5 shows a screen projection method based on a wireless auxiliary stream device 1. With reference to FIG. 1, in this embodiment, the wireless auxiliary stream device 1 is communicatively connected to a terminal device 2, and the wireless auxiliary stream device 1 is wirelessly connected to a video conferencing host 3. The terminal device communicates wirelessly with the video conferencing host through the wireless auxiliary stream device to transmit audio and video data. The terminal device 2 communicates wirelessly with the video conferencing host 3 through the wireless auxiliary stream device 1 to transmit audio and video data, such that the audio and video data is displayed or played on an audio and video device connected to the video conferencing host, thereby ultimately transmitting, displaying, and playing the audio and video data. The wireless auxiliary stream device 1 includes a first transmission module 11, a second transmission module 12, a processor 13, and a power supply module 14. A screen projection method based on a wireless auxiliary stream device 1 includes following steps:

Step S10: Obtain electric power from the power supply module 14 to supply power to the wireless auxiliary stream device 1, such that the wireless auxiliary stream device is maintained in a standby mode, where the power supply module 14 has a power supply mode and a charging mode. The power supply module 14 can supply power to the wireless auxiliary stream device to enable the wireless auxiliary stream device to be in the standby mode. When the wireless auxiliary stream device 1 is disconnected from the terminal device 2, the power supply module 14 immediately continues to supply power to the wireless auxiliary stream device 1, such that the wireless auxiliary stream device 1 is maintained in the standby mode. At this time, the power supply module 14 is in the power supply mode, so as to provide necessary power support for the wireless auxiliary stream device 1 at any time during the standby mode, thereby ensuring that the wireless auxiliary stream device can quickly switch from the standby mode to a working mode and shortening response time.

Step S20: When the first transmission module 11 is communicatively connected to the terminal device 2, switch the wireless auxiliary stream device from the standby mode to the working mode. Because the wireless auxiliary stream device is always in the standby mode, once detecting a connection request or a screen projection instruction from the terminal device 2, the wireless auxiliary stream device 1 can quickly respond, wake up a relevant functional module, and enter a normal working mode without being powered on and initialized again or re-establishing a connection to the video conferencing host 3, thereby achieving extremely short response time.

Step S30: Receive the audio and video data from the terminal device 2 through the first transmission module 11, and transmit the received audio and video data to the second transmission module 12. Step S40: Send the received audio and video data to the video conferencing host 3 through the second transmission module 12, such that the audio and video data is finally displayed or played on the audio and video device connected to the video conferencing host 3.

As a preferred solution, when the first transmission module 11 is communicatively connected to the terminal device 2, a first signal is sent to the power supply module 14 through the first transmission module 11, such that the power supply module 14 switches to the charging mode after receiving the first signal. When the wireless auxiliary stream device 1 is inserted into the terminal device 2 through a USB interface, the terminal device 2 can send a control signal, namely, the first signal, to the wireless auxiliary stream device 1 through the first transmission module 11, and control the power supply module 14 to switch to the charging mode. Ideally, the power supply module 14 switches to the charging mode only after the terminal device 2 provides an electricity quantity required for normal working of the wireless auxiliary stream device 1 through the first transmission module 11, so as to synchronously maintain an electricity quantity required for the normal working and the subsequent standby mode of the wireless auxiliary stream device 1. This ensures that the wireless auxiliary stream device 1 can quickly switch from the standby mode to the working mode, and shortens the response time.

As a preferred solution, after the first transmission module 11 is communicatively connected to the terminal device 2, a current electricity quantity of the power supply module is detected, and the power supply module 14 is controlled to switch to the charging mode when the current electricity quantity is lower than a preset threshold. Specifically, the preset threshold may be an electricity quantity required by the wireless auxiliary stream device 1 to maintain the standby mode for 3 to 15 hours, to ensure a sufficient battery life for the wireless auxiliary stream device 1 to maintain the standby mode. When being connected to the terminal device, the wireless auxiliary stream device 1 can quickly switch to the working mode without a need to wait for power-on and initialization of the wireless auxiliary stream device 1 and a pairing and connection process between the second transmission module 12 and the video conferencing host 3, greatly reducing waiting time for screen sharing and significantly improving sharing efficiency.

Referring to FIG. 1 to FIG. 4, a screen projection system containing a wireless auxiliary stream device is shown, which includes at least a fast-started wireless auxiliary stream device 1, a terminal device 2, and a video conferencing host 3 as described in the above embodiments. The wireless auxiliary stream device 1 is communicatively connected to the terminal device 2, and the wireless auxiliary stream device 1 is wirelessly connected to the video conferencing host 3. The terminal device 2 communicates wirelessly with the video conferencing host 3 through the wireless auxiliary stream device 1 to transmit audio and video data. The terminal device 2 communicates wirelessly with the video conferencing host 3 through the wireless auxiliary stream device 1 to transmit audio and video data, such that the audio and video data is displayed or played on an audio and video device connected to the video conferencing host, thereby ultimately transmitting, displaying, and playing the audio and video data. The wireless auxiliary stream device 1 is equipped with an independent power supply module 14. The power supply module 14 can supply power to each module of the wireless auxiliary stream device 1, such that the wireless auxiliary stream device 1 is maintained in a standby mode. In this way, the power supply module 14 can provide necessary power support to the wireless auxiliary stream device 1 at any time during the standby mode. This ensures that the wireless auxiliary stream device can quickly switch from the standby mode to a working mode, achieves fast startup of the wireless auxiliary stream device, and shortens response time.

In the embodiments of the present disclosure, the first transmission module, the second transmission module, and the power detection module each may be at least one processor, controller, or chip that has a communication interface, can realize a communication protocol, and may further include a memory, a related interface and system transmission bus, and the like if necessary. The processor, the controller, or the chip executes program-related code to realize a corresponding function. In an alternative solution, the first transmission module, the second transmission module, and the power detection module share an integrated chip or share devices such as a processor, a controller, and a memory. The shared processor, controller, or chip executes program-related code to implement a corresponding function.

Compared with the prior art, the embodiments of the present disclosure have following beneficial effects:

The present disclosure provides a wireless auxiliary stream device. The wireless auxiliary stream device includes: a first transmission module configured to establish a communication connection between the wireless auxiliary stream device and a terminal device, where the wireless auxiliary stream device receives audio and video data from the terminal device through the first transmission module; a second transmission module configured to wirelessly send the audio and video data received by the wireless auxiliary stream device to a video conferencing host, such that the audio and video data is displayed or played on an audio and video device connected to the video conferencing host; and a power supply module configured to supply power to the wireless auxiliary stream device, such that the wireless auxiliary stream device is maintained in a standby mode, where the power supply module has a power supply mode and a charging mode. Compared with the prior art, the power supply module can independently supply power to the wireless auxiliary stream device to enable the wireless auxiliary stream device to be in the standby mode. When the wireless auxiliary stream device is disconnected from the terminal device, the power supply module immediately continues to supply power to the wireless auxiliary stream device, such that the wireless auxiliary stream device is maintained in the standby mode. At this time, the power supply module is in the power supply mode. In the standby mode, most functional modules of the wireless auxiliary stream device are in a low-power running mode to reduce an energy consumption. In the standby mode, the wireless auxiliary stream device will continuously monitor a connection status with the terminal device or maintain a connection status with the video conferencing host, and can quickly respond, wake up a relevant functional module, and enter a normal working mode once detecting a connection request or a screen projection instruction from the terminal device. This ensures that the wireless auxiliary stream device can quickly switch from the standby mode to a working mode and shortens response time.

The objectives, technical solutions, and beneficial effects of the present disclosure are further described in detail through the above specific embodiments. It should be understood that the above are merely some specific embodiments of the present disclosure, but are not intended to limit the protection scope of the present disclosure. It should be particularly noted that, any modifications, equivalent substitutions, improvements, and the like made by those skilled in the art within the spirit and principle of the present disclosure should be included within the protection scope of the present disclosure.

1. A wireless auxiliary stream device, wherein the wireless auxiliary stream device is communicatively connected to a terminal device; the wireless auxiliary stream device is wirelessly connected to a video conferencing host; the terminal device communicates wirelessly with the video conferencing host through the wireless auxiliary stream device to transmit audio and video data; and the wireless auxiliary stream device comprises:
a first transmission module configured to establish a communication connection between the wireless auxiliary stream device and the terminal device, wherein the wireless auxiliary stream device receives the audio and video data from the terminal device through the first transmission module;
a second transmission module configured to wirelessly send the audio and video data received by the wireless auxiliary stream device to the video conferencing host, whereby the audio and video data is displayed or played on an audio and video device connected to the video conferencing host;
a power supply module configured to supply power to the wireless auxiliary stream device, whereby the wireless auxiliary stream device is maintained in a standby mode, wherein the power supply module has a power supply mode and a charging mode; and
a processor connected separately to the first transmission module, the second transmission module, and the power supply module and configured to control the connected first transmission module, second transmission module, and power supply module.

2. The wireless auxiliary stream device according to claim 1, wherein the power supply module is connected to the first transmission module and the second transmission module, and is configured to directly supply power to the first transmission module and the second transmission module to provide an electricity quantity required for transmitting the audio and video data.

3. The wireless auxiliary stream device according to claim 1, wherein the power supply module is a rechargeable battery.

4. The wireless auxiliary stream device according to claim 1, wherein the first transmission module of the wireless auxiliary stream device further comprises a charging interface, and when the wireless auxiliary stream device is communicatively connected to the terminal device through the first transmission module, the terminal device charges the power supply module through the charging interface of the first transmission module.

5. The wireless auxiliary stream device according to claim 4, wherein the terminal device supplies power to the second transmission module through the first transmission module to provide an electricity quantity required for wirelessly sending the audio and video data received by the wireless auxiliary stream device to the video conferencing host.

6. The wireless auxiliary stream device according to claim 4, wherein the first transmission module is configured to send a first signal to the power supply module when being communicatively connected to the terminal device, and the power supply module is configured to switch to the charging mode after receiving the first signal.

7. The wireless auxiliary stream device according to claim 1, further comprising a power detection module, wherein the power detection module is configured to detect a current electricity quantity of the power supply module; and
after the first transmission module is communicatively connected to the terminal device, the power detection module is further configured to control the power supply module to switch to the charging mode when detecting that the current electricity quantity of the power supply module is lower than a preset threshold.

8. The wireless auxiliary stream device according to claim 2, further comprising a charging module, wherein the wireless auxiliary stream device charges the power supply module through the charging module.

9. The wireless auxiliary stream device according to claim 1, wherein the first transmission module is a universal physical interface, and the second transmission module is a wireless transmission module.

10. A screen projection method based on a wireless auxiliary stream device, applied to the wireless auxiliary stream device, wherein the wireless auxiliary stream device is communicatively connected to a terminal device; the wireless auxiliary stream device is wirelessly connected to a video conferencing host; the terminal device communicates wirelessly with the video conferencing host through the wireless auxiliary stream device to transmit audio and video data; and the screen projection method comprises:
obtaining electric power from a power supply module of the wireless auxiliary stream device to supply power to the wireless auxiliary stream device, whereby the wireless auxiliary stream device is maintained in a standby mode, wherein the power supply module has a power supply mode and a charging mode;
when a first transmission module of the wireless auxiliary stream device is communicatively connected to the terminal device, switching the wireless auxiliary stream device from the standby mode to a working mode;
receiving the audio and video data from the terminal device through the first transmission module, and transmitting the received audio and video data to a second transmission module of the wireless auxiliary stream device; and
wirelessly sending the received audio and video data to the video conferencing host through the second transmission module.

11. The screen projection method based on a wireless auxiliary stream device according to claim 10, further comprising:
when the first transmission module is communicatively connected to the terminal device, controlling the first transmission module to send a first signal to the power supply module, whereby the power supply module switches to the charging mode after receiving the first signal.

12. The screen projection method based on a wireless auxiliary stream device according to claim 10, further comprising:
after the first transmission module is communicatively connected to the terminal device, detecting a current electricity quantity of the power supply module, and controlling the power supply module to switch to the charging mode when the current electricity quantity is lower than a preset threshold.

13. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 1.

14. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 2.

15. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 3.

16. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 4.

17. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 5.

18. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 6.

19. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 7.

20. A screen projection system containing a wireless auxiliary stream device, wherein the screen projection system comprises a terminal device, the wireless auxiliary stream device, and a video conferencing host, wherein
the wireless auxiliary stream device is communicatively connected to the terminal device;
the wireless auxiliary stream device is wirelessly connected to the video conferencing host; and
the terminal device communicates wirelessly with the video conferencing host through the wireless auxiliary stream device to transmit audio and video data, and the wireless auxiliary stream device is the wireless auxiliary stream device according to claim 8.
